(19) United States
(12) Patent Application Publication
(10) Pub. No.: US 2019/0122309 A1
(43) Pub. Date: Apr. 25, 2019

(54) INCREASING SOCIAL MEDIA EXPOSURE BY AUTOMATICALLY GENERATING TAGS FOR CONTENTS

(71) Applicant: CRACKLE, INC., Culver City, CA (US)

(72) Inventors: Aaron Goldstein, Culver City, CA (US); Christine Coner, Culver City, CA (US); Ihor Yaskiw, Culver City, CA (US)

(21) Appl. No.: 15/791,175

(22) Filed: Oct. 23, 2017

(51) Int. Cl. G06Q 50/00

(52) U.S. Cl. CPC G06Q 50/01; G06F 3/0482

(57) ABSTRACT

Automatically generating tags for contents, including: processing the contents to identify items and elements in the contents; processing the contents to identify social media patterns of a user and social media trends;

extracting environmental variables of the contents from metadata associated with the contents; receiving the identified items and elements, the identified social media patterns and social media trends, and the extracted environmental variables; and generating tags for the contents by processing the identified items and elements, the identified social media patterns and social media trends, and the extracted environmental variables. Keywords include hashtag, social media, and image detection.

### BACKGROUND

### Field

The present disclosure relates to tags for contents, and more specifically, to automatically generating tags to increase social media exposure.

### Background

Photo tagging has been used to provide an effective organization of a collection of photographs. For example, a photograph can be tagged with metadata as a description about that photograph. Photo sharing has also become an increasingly popular activity. For example, people attending the same event often share photographs taken at an event with each other. The photographs can be shared using an online service (e.g., a social network), passing around memory cards, or via messaging (e.g., email or text message). Social network systems often enable users to upload photographs and to create photo albums containing the uploaded photographs. Further, some social network systems allow a user to apply tags such as captions or labels to the photographs.

### SUMMARY

The present disclosure provides for automatically generating tags, presenting the generated tags to the user, enabling the user to select tags, tagging the contents with the selected tags, and sharing the tagged contents.

In one implementation, a system for automatically generating tags for contents is disclosed. The system includes: a content recognition unit configured to receive and process the contents by identifying items and elements in the contents; a social media pattern recognition unit configured to process and recognize social media patterns of a user and social media trends and to generate an identifiable structure or list; an environmental variables recognition unit configured to process and identify environmental variables; and a tag generator configured to receive a plurality of metrics including (a) the identified items and elements from the content recognition unit, (b) the identifiable structure or list of the social media patterns and the social media trends from the social media pattern recognition unit, and (c) the identified environmental variables from the environmental variables recognition unit, wherein the tag generator is configured to generate possible tags for the contents by processing the plurality of metrics.

In another implementation, a method for automatically generating tags for contents is disclosed. The method includes: processing the contents to identify items and elements in the contents; processing the contents to identify social media patterns of a user and social media trends; extracting environmental variables of the contents from metadata associated with the contents; receiving the identified items and elements, the identified social media patterns and social media trends, and the extracted environmental variables; and generating tags for the contents by processing the identified items and elements, the identified social media patterns and social media trends, and the extracted environmental variables.

In yet another implementation, a non-transitory computer-readable storage medium storing a computer program to automatically generate tags for contents is disclosed. The computer program includes executable instructions that cause a computer to: process the contents to identify items and elements in the contents; process the contents to identify social media patterns of a user and social media trends; extract environmental variables of the contents from metadata associated with the contents; receive the identified items and elements, the identified social media patterns and social media trends, and the extracted environmental variables; and generate tags for the contents by processing the identified items and elements, the identified social media patterns and social media trends, and the extracted environmental variables.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a block diagram showing a tag generation system in accordance with one implementation of the present disclosure;

FIGS. 2A and 2B represent a flow diagram illustrating a process for generating tags for contents in accordance with one implementation of the present disclosure;

FIG. 3A illustrates the user capturing an image of a hot dog using an auto-tagging application loaded in a mobile device;

FIG. 3B shows the auto-tagging application ranking hashtags based on how they are currently trending and suggesting top ones to a user;

FIG. 3C shows the auto-tagging application enabling the user to select a portion or all of the suggested hashtags to accompany the posting of the image to a social media platform;

FIG. 4A is a representation of a computer system and a user in accordance with an implementation of the present disclosure; and

FIG. 4B is a functional block diagram illustrating the computer system hosting the auto-tagging application in accordance with an implementation of the present disclosure.

### DETAILED DESCRIPTION

As described above, sharing of photographs (and in general, contents) has become an increasingly popular activity, and some social network systems allow a user to apply tags such as captions or labels to the photographs.

Certain implementations of the present disclosure provide for automatically generating tags including hashtags for contents (such as photographs and videos), presenting the generated tags to the user, enabling the user to select tags, tagging the contents with the selected tags, and sharing the tagged contents. After reading these descriptions, it will become apparent how to implement the disclosure in various implementations and applications. Although various implementations of the present disclosure will be described herein, it is understood that these implementations are presented by way of example only, and not limitation. As such, this detailed description of various implementations should not be construed to limit the scope or breadth of the present disclosure.

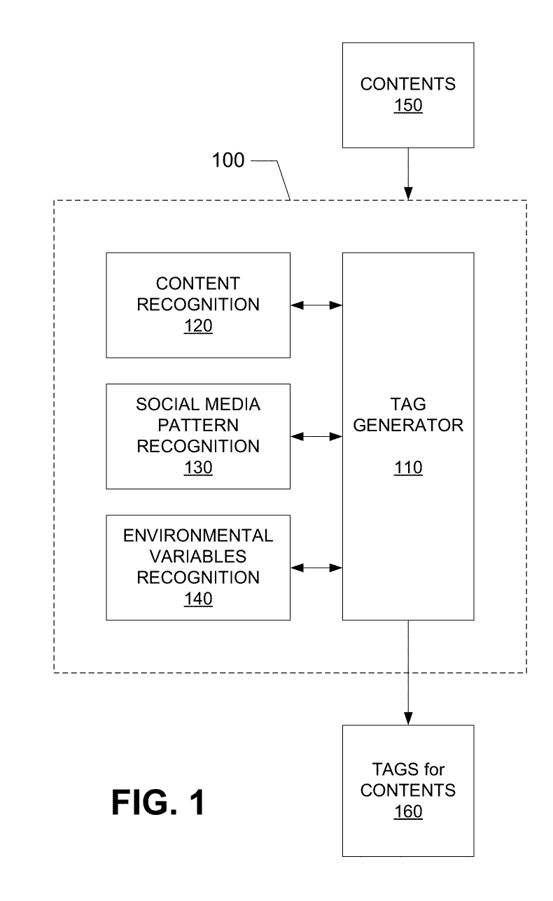

FIG. 1 is a block diagram showing a tag generation system 100 in accordance with one implementation of the present disclosure. In one implementation, the tag generation system 100 is a system configured entirely with hardware including one or more digital signal processors (DSPs), general purpose microprocessors, application specific integrated circuits (ASICs), field programmable logic arrays (FPGAs), or other equivalent integrated or discrete logic circuitry. In another implementation, the tag generation system 100 is configured with a combination of hardware and software.

In the illustrated implementation of FIG. 1, the tag generation system 100 includes a tag generator 110, a content recognition unit 120, a social media pattern recognition unit 130, and an environmental variables recognition unit 140. In one implementation, the tag generation system 100 is configured to process the contents 150 and predict and/or recommend tags 160 for each of the contents.

In one implementation, the content recognition unit 120 is configured to receive and process the contents 150 by recognizing items and/or elements in the contents. For image contents, the content recognition unit 120 may be configured to process the received contents to recognize items within an image such as make and model of a car, names of the people, and identification of other relevant objects. For video contents, the content recognition unit 120 may be configured to identify the people in the video. Once the content recognition unit 120 has identified the items and/or elements in the contents 150, the identified items and/or elements are sent to the tag generator 110.

In one implementation, the social media pattern recognition unit 130 is configured to process and recognize the social media patterns of the user and the social media trends. In one implementation, the social media patterns refer to the usage patterns of the social media sites by the user. For example, the usage patterns may include how often the user logs into Facebook®, Instagram®, or Twitter®, what type of friends are included in the account, what type of people the user follows, and what type of messages the user reads. In another implementation, the social media trends refer to issues and trends that are of interest to users of social media. For example, the issues and trends may include items and/or videos in the trending section of YouTube®. In one implementation, the social media patterns of the user and the social media trends are extracted and/or identified from social network service applications stored on a mobile device using the user account information. In one implementation, the tag generation system 100 also resides on the mobile device.

In one implementation, the unit 130 then organizes the social media patterns of the user and/or the social media trends into an identifiable structure or list. In one implementation, the identifiable structure or list includes information extracted from the social media patterns and the social media trends and organized into a structure or list so that the extracted information can be easily viewed and processed by the tag generation system 100. Once the social media pattern recognition unit 130 has generated the identifiable structure or list, the identifiable structure or list is sent to the tag generator 110.

In one implementation, the environmental variables recognition unit 140 is configured to process and identify environmental variables such as a location (e.g., a user location), a time of day, a user data (e.g., name and age of the user), and/or a name of the show or event in the video. In one implementation, some environmental variables, such as the location, the time of day, and the user data, are extracted from the metadata attached to the contents. In another implementation, some environmental variables are identified and/or recognized from elements or objects in the contents. For example, a time of day can be identified from an image with a digital clock. Again, once the environmental variables recognition unit 140 has identified the environmental variables, the variables are sent to the tag generator 110.

Once the tag generator 110 receives the identified items and/or elements from the content recognition unit 120, the identifiable structure or list of the social media patterns and/or the trends from the social media pattern recognition unit 130, and the environmental variables from the environmental variables recognition unit 140, the tag generator 110 combines and processes the received metrics (e.g., items, elements, lists, and variables) to generate, predict, and recommend possible tags 160 for the contents 150. Thus, the metrics are collectively used to suggest to the user one or more tags/metadata with a goal of maximizing exposure in a social network environment of the user. In one implementation, once the user receives the suggested one or more tags, the user may select one or more tags for attaching the tags to the contents and posting the tagged contents to social network platforms such as Facebook®, Instagram®, Twitter®, or YouTube®.

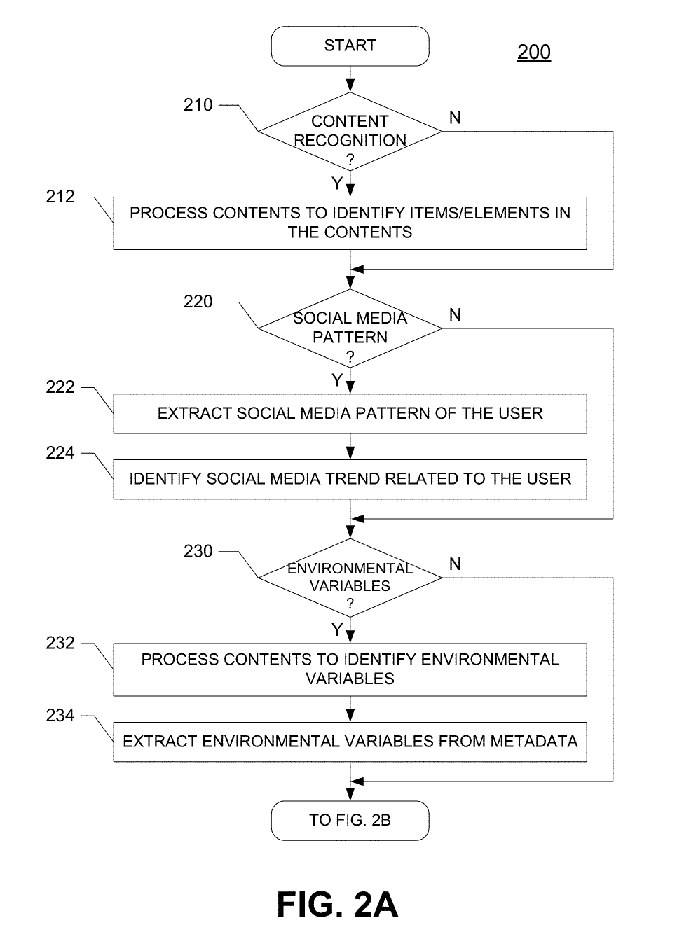

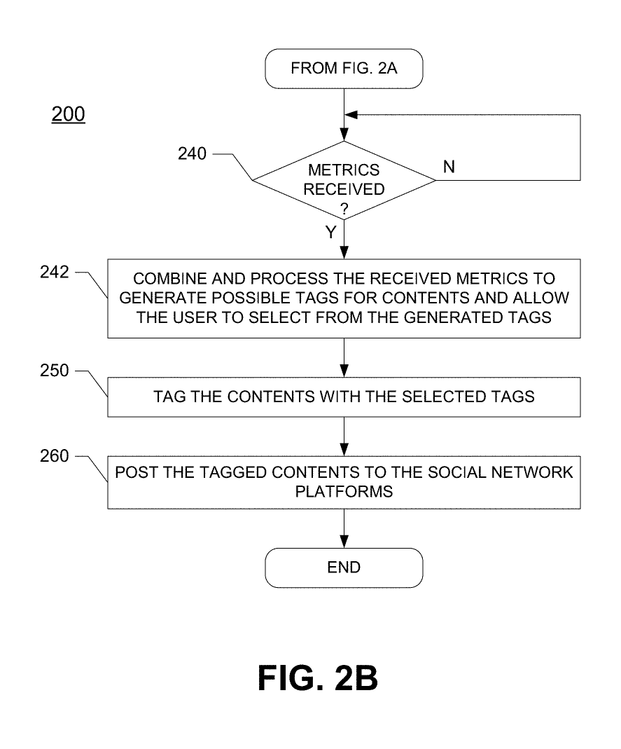

FIGS. 2A and 2B represent a flow diagram illustrating a process 200 for automatically generating tags for contents in accordance with one implementation of the present disclosure. In the illustrated implementation of FIG. 2A, contents are received and a check is made, at block 210, to determine whether to process the contents. If the processing of the contents is desired, the contents are processed, at block 212, to identify the items and/or elements in the contents. For image contents, the contents may be processed to recognize items within an image such as make and model of a car, names of the people, and identification of other relevant objects (e.g., using an image detection engine or object or face recognition system). For video contents, the contents may be processed to identify the people in the video.

A check is made, at block 220, to determine whether to process the social media patterns and trends of the user. If the processing of the social media patterns and trends of the user is desired, the social media patterns are extracted, at block 222, and the social media trends are identified, at block 224. As stated above, in one implementation, the social media patterns of the user and the social media trends are extracted and/or identified from the social network service applications stored on the mobile device using the user account information.

A check is then made, at block 230, to determine whether to recognize and/or extract the environmental variables such as a location (e.g., a user location), a time of day, a user data (e.g., name and age of the user), and/or a name of the show or event in the video. If the recognition/extraction of the environmental variables is desired, the contents are processed, at block 232, to identify the environmental variables contained in the contents. In some implementations, the recognized and/or extracted environmental variables overlap with the items within the content identified and/or recognized at block 212. However, the environmental variables recognized and/or identified at block 232 generally include environmental items such as time, location, and name of place. Accordingly, in another implementation, the environmental variables are extracted, at block 234, from the metadata of the contents.

A check is then made, at block 240, to determine whether the metrics (e.g., items, elements, lists, and variables) generated have been received. If the metrics have been received, the received metrics are used or combined, at block 242, to generate possible tags for the contents and allow the user to select from the generated tags. In one implementation, the tags are generated and presented to the user through a graphical user interface (GUI) associated with a tag generation application residing on the mobile device. The user selects one or more tags using the GUI and the selection is received by the tag generation application.

Once the user has selected tags, the contents are tagged, at block 250, with the selected tags. In one implementation, the contents are tagged using applications associated with the social media platforms. For example, the user opens an application associated with Instagram and selects image(s) and connects the image(s) to the selected tag(s). In another example, a particular person in an image may be tagged by opening the image, selecting the person in the image, and attaching the selected tag to the person in the image. In another implementation, the selected tag is stored in metadata associated with the content. The tagged contents are then posted, at block 260, to the social network platforms.

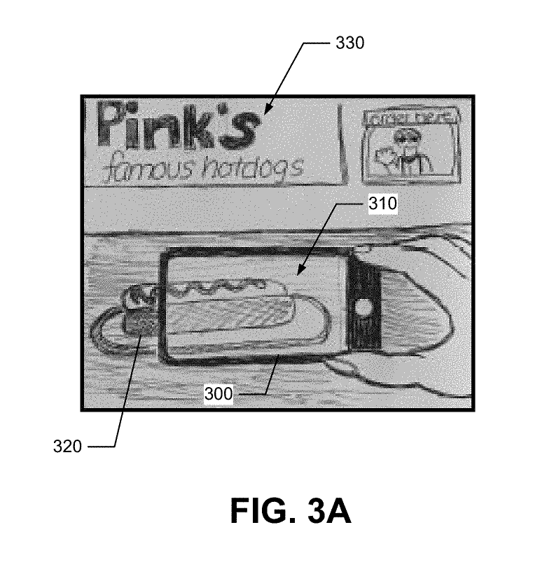

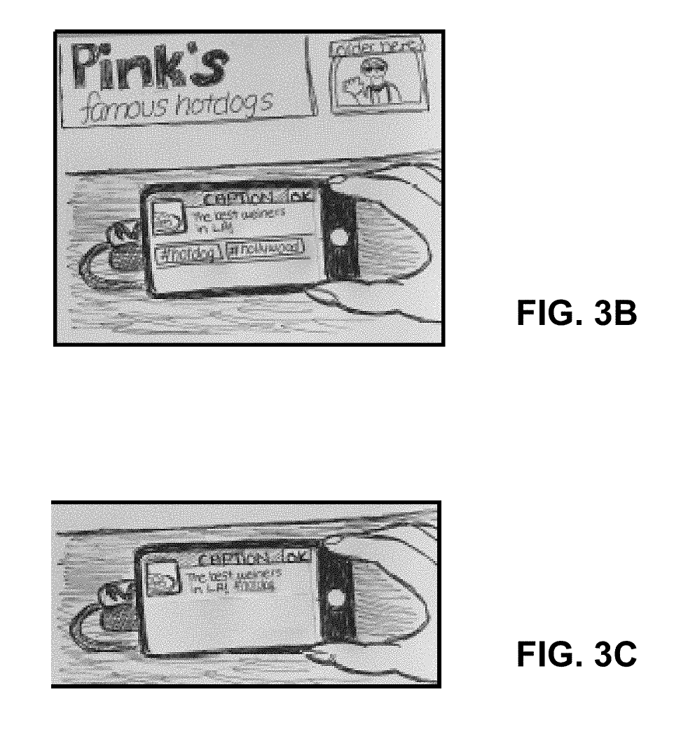

FIGS. 3A, 3B, and 3C represent an example use of an application for generating tags for contents implemented on a mobile device in accordance with one implementation of the present disclosure. In the illustrated implementation of FIGS. 3A to 3C, the user captures an image or photograph of a hot dog (e.g., using a mobile device) while at Pink's in Hollywood at noon and starts the process of uploading it to a social media platform (e.g., Instagram).

FIG. 3A illustrates the user capturing the image 310 of the hot dog 320 using an auto-tagging application loaded in the mobile device 300. In one implementation, an image detection engine of the auto-tagging application recognizes the hot dog 320 in the image 310. The image detection engine may also recognize the logo “Pink's” 330 in the background of the image 310. In another implementation, a location-based service engine of the auto-tagging application determines the location of the image 310 to be at Pink's restaurant in Hollywood. In yet another implementation, the auto-tagging application determines from the time information of the device 300 that the time at which the image 310 was taken is 12:00 pm or “lunchtime”. In a further implementation, the auto-tagging application retrieves any other relevant data that the user has made accessible on the mobile device 300. The relevant data may include demographics, interests, search history, and past posts.

In one implementation, the auto-tagging application receives and analyzes the data packets identified and/or collected by the engines and data collectors of the mobile device 300 as noted above. For the example image 310 shown in FIG. 3A, the auto-tagging application analyzes the data packets and cross-references them against relevant internet resources (e.g., trending hashtags and related queries) to extrapolate contextually relevant tags or hashtags based on individual elements of the data packets or a combination thereof. Thus, for the example illustrated in FIG. 3A, the possible hashtags that may be suggested by the auto-tagging application include hashtags #pinkshotdogs, #hotdog, #hotdogsfordays, #hotdogsforlunch, and #hotdogsinhollywood.

In the illustrated implementation shown in FIG. 3B, the auto-tagging application ranks the above hashtags based on how they are currently trending and suggests the top ones to the user. In the illustrated implementation shown in FIG. 3C, the auto-tagging application enables the user to select a portion or all of the suggested hashtags to accompany the posting of the image 310 to at least one of the social media platforms such as Instagram, Facebook, or Snapchat.

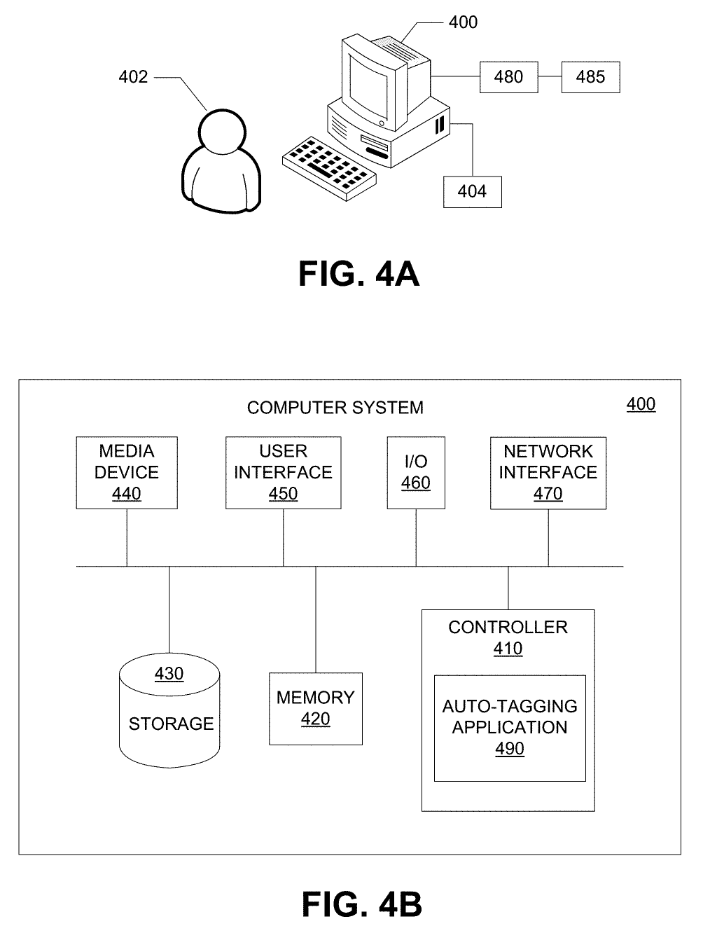

FIG. 4A is a representation of a computer system 400 and a user 402 in accordance with an implementation of the present disclosure. The user 402 uses the computer system 400 to implement an auto-tagging application. The computer system 400 stores and executes the auto-tagging application 490 of FIG. 4B. In addition, the computer system 400 may be in communication with a software program 404. Software program 404 may include the software code for the auto-tagging application. Software program 404 may be loaded on an external medium such as a CD, DVD, or a storage drive, as will be explained further below.

Furthermore, computer system 400 may be connected to a network 480. The network 480 can be connected in various different architectures, for example, client-server architecture, a Peer-to-Peer network architecture, or other type of architectures. For example, network 480 can be in communication with a server 485 that coordinates engines and data used within the auto-tagging application. Also, the network can be different types of networks. For example, the network 480 can be the Internet, a Local Area Network or any variations of Local Area Network, a Wide Area Network, a Metropolitan Area Network, an Intranet or Extranet, or a wireless network.

FIG. 4B is a functional block diagram illustrating the computer system 400 hosting the auto-tagging application 490 in accordance with an implementation of the present disclosure. A controller 410 is a programmable processor and controls the operation of the computer system 400 and its components. The controller 410 loads instructions (e.g., in the form of a computer program) from the memory 420 or an embedded controller memory (not shown) and executes these instructions to control the system. In its execution, the controller 410 provides the auto-tagging application 490 with a software system, such as to enable the creation and configuration of engines and data extractors within the auto-tagging application. Alternatively, this service can be implemented as separate hardware components in the controller 410 or the computer system 400.

Memory 420 stores data temporarily for use by the other components of the computer system 400. In one implementation, memory 420 is implemented as RAM. In one implementation, memory 420 also includes long-term or permanent memory, such as flash memory and/or ROM.

Storage 430 stores data either temporarily or for long periods of time for use by the other components of computer system 400. For example, storage 430 stores data used by the auto-tagging application 490. In one implementation, storage 430 is a hard disk drive.

The media device 440 receives removable media and reads and/or writes data to the inserted media. In one implementation, for example, the media device 440 is an optical disc drive.

The user interface 450 includes components for accepting user input from the user of the computer system 400 and presenting information to the user 402. In one implementation, the user interface 450 includes a keyboard, a mouse, audio speakers, and a display. The controller 410 uses input from the user 402 to adjust the operation of the computer system 400.

The I/O interface 460 includes one or more I/O ports to connect to corresponding I/O devices, such as external storage or supplemental devices (e.g., a printer or a PDA). In one implementation, the ports of the I/O interface 460 include ports such as: USB ports, PCMCIA ports, serial ports, and/or parallel ports. In another implementation, the I/O interface 460 includes a wireless interface for communication with external devices wirelessly.

The network interface 470 includes a wired and/or wireless network connection, such as an RJ-45 or “Wi-Fi” interface (including, but not limited to 802.11) supporting an Ethernet connection.

The computer system 400 includes additional hardware and software typical of computer systems (e.g., power, cooling, operating system), though these components are not specifically shown in FIG. 4B for simplicity. In other implementations, different configurations of the computer system can be used (e.g., different bus or storage configurations or a multi-processor configuration).

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. For example, although the specification describes the auto-tagging application processing only image and video contents, the application can receive and process other contents including email, text, and 3-D virtual reality (VR) contents. In another example, although the specification describes tags only in terms of hashtags, tag can

Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A system for automatically generating tags for contents, the system comprising:
a content recognition unit configured to receive and process the contents by identifying items and elements in the contents;
a social media pattern recognition unit configured to process and recognize social media patterns of a user and social media trends and to generate an identifiable structure or list;
an environmental variables recognition unit configured to process and identify environmental variables; and
a tag generator configured to receive a plurality of metrics including (a) the identified items and elements from the content recognition unit, (b) the identifiable structure or list of the social media patterns and the social media trends from the social media pattern recognition unit, and (c) the identified environmental variables from the environmental variables recognition unit,
wherein the tag generator is configured to generate possible tags for the contents by processing the plurality of metrics.

2. The system of claim 1, wherein the contents comprise photographs.

3. The system of claim 2, wherein the identified items and elements comprise at least one of
make and model of a car, names of people shown in the contents, and identification of objects in the photographs.

4. The system of claim 1, wherein the contents comprise videos.

5. The system of claim 4, wherein the identified items and elements comprise people in the videos.

6. The system of claim 1, wherein the environmental variables comprise at least one of
a location of the user, a time of day, a user data, and a name of a show or event extracted from metadata attached to the contents.

7. A method for automatically generating tags for contents, the method comprising:
processing the contents to identify items and elements in the contents;
processing the contents to identify social media patterns of a user and social media trends;
extracting environmental variables of the contents from metadata associated with the contents;
receiving the identified items and elements, the identified social media patterns and social media trends, and the extracted environmental variables; and
generating tags for the contents by processing the identified items and elements, the identified social media patterns and social media trends, and the extracted environmental variables.

8. The method of claim 7, further comprising
enabling the user to select at least one tag from the generated tags.

9. The method of claim 8, further comprising
tagging the contents with the selected at least one tag.

10. The method of claim 9, further comprising
posting the tagged contents to social network platforms.

11. The method of claim 7, wherein the contents comprise photographs.

12. The method of claim 11, wherein the identified items and elements comprise at least one of
make and model of a car, names of people shown in the contents, and identification of objects in the photographs.

13. The method of claim 7, wherein the contents comprise videos.

14. The method of claim 4, wherein the identified items and elements comprise people in the videos.

15. The method of claim 7, wherein the environmental variables are extracted from metadata attached to the contents.

16. The method of claim 7, wherein the environmental variables are recognized from objects in the contents.

17. A non-transitory computer-readable storage medium storing a computer program to automatically generate tags for contents, the computer program comprising executable instructions that cause a computer to:
process the contents to identify items and elements in the contents;
process the contents to identify social media patterns of a user and social media trends;
extract environmental variables of the contents from metadata associated with the contents;
receive the identified items and elements, the identified social media patterns and social media trends, and the extracted environmental variables; and
generate tags for the contents by processing the identified items and elements, the identified social media patterns and social media trends, and the extracted environmental variables.

18. The non-transitory storage medium of claim 17, further comprising executable instructions that cause the computer to
enable the user to select at least one tag from the generated tags.

19. The non-transitory storage medium of claim 18, further comprising executable instructions that cause the computer to
tag the contents with the selected at least one tag.

20. The non-transitory storage medium of claim 19, further comprising executable instructions that cause the computer to
post the tagged contents to at least one social network platform.
